(19) United States
(12) Patent Application Publication
(10) Pub. No.: US 2025/0072410 A1
(43) Pub. Date: Mar. 6, 2025

(54) METHOD AND APPARATUS FOR MONITORING STICKY BOARD INSECT TRAPS

(71) Applicant: Ecolab USA Inc., Saint Paul, MN (US)

(72) Inventors: Narendra Aswathanarayana Setty, Naperville, IL (US); Magesh Kumar Jaganathan, Aurora, IL (US); Robert Anthony Krokos, Oak Lawn, IL (US); Daniel Ronald Schwartz, Cottage Grove, MN (US)

(21) Appl. No.: 18/820,535

(22) Filed: Aug. 30, 2024

Related U.S. Application Data
(60) Provisional application No. 63/536,166, filed on Sep. 1, 2023.

(51) Int. Cl. A01M 1/02; A01M 1/10; A01M 1/14

(52) U.S. Cl. CPC A01M 1/026; A01M 1/10; A01M 1/145; A01M 2200/01

(57) ABSTRACT

A system and method for processing and analyzing a photographic image of a board having a sticky surface of an insect traps allows for remote monitoring of deployed insect traps to maintain effectiveness of the insect traps while eliminating the need for frequent manual inspections. The processing and analyzing can include converting the photographic image to a grayscale image and determining a concentration of insects on the board and can be performed using edge computing.

### CROSS-REFERENCE TO RELATED APPLICATION

This patent application claims the benefit of U.S. Provisional Patent Application No. 63/536,166, filed Sep. 1, 2023, which is incorporated by reference herein in its entirety.

### TECHNICAL FIELD

The present disclosure relates generally to pest control and more particularly to a method and apparatus for monitoring insect traps each having a sticky board by processing and analyzing a photographic image of each sticky board to determine its status, for example using edge computing.

### BACKGROUND

Sticky boards are used for pest control by themselves or in combination with attracting means to lure pests onto the sticky boards. Effectiveness of a sticky board depends on where it is placed and the area of its sticky surface, which decreases with the number of pests being trapped. Once deployed, the sticky board needs to be monitored for need of repositioning and/or replacement as well as for indication of pest infestation. Such monitoring is a tedious and time-consuming task. For example, a pest control service provider may deploy many pest control devices including sticky boards in a customer's site and then visit the site on a periodic basis to monitor the status of each sticky board. Frequent visit may be desirable or necessary for effective pest control by ensuring effectiveness of the sticky boards and/or identifying signs of pest infestation.

### SUMMARY

A system and method for processing and analyzing a photographic image of a sticky board of an insect traps allows for remote monitoring of deployed insect traps to maintain effectiveness of the insect traps while eliminating the need for frequent manual inspections. The processing and analyzing can include converting the photographic image to a grayscale image and determining a concentration of insects on the sticky board and can be performed using edge computing.

An example of a system for insect control using insect traps is provided. The insect traps may each include a sticky board having a sticky surface. The system may include a camera and an image processor. The camera may be configured to take a photograph showing the sticky surface of the sticky board of each insect trap of the insect traps and to generate an image file representing the photograph. The image processor may be communicatively coupled to the camera and may be configured to generate a grayscale image of the sticky surface by processing the image file and analyze the grayscale image to determine status information indicating a status of the sticky board, the status information including a measure of a concentration of insects on the sticky surface.

An example of a method for insect control insect traps is also provided. The insect traps may each include a sticky board having a sticky surface. The method may include receiving an image file representing a photograph showing the sticky surface of the sticky board of each insect trap of the insect traps, generating a grayscale image of the sticky surface by processing the image file using an image processor, and analyzing the grayscale image to determine status information indicating a status of the sticky board using the image processor. The status information includes a measure of concentration of insects on the sticky surface.

This summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1 shows a block diagram illustrating an embodiment of a pest control system.

FIG. 2 shows a block illustrating an embodiment of a gateway device, such as an example of the gateway device of FIG. 1.

FIG. 3 shows a block illustrating an embodiment of an insect trap, such as an example of the insect traps of FIG. 1.

FIG. 4 shows a perspective view illustrating an embodiment of an insect trap, such as an example of the insect trap of FIG. 3.

FIG. 5 shows an illustration of a photographic image showing a sticky surface of a sticky board of an insect trap, such as the insect trap of FIG. 3.

FIG. 6 shows an illustration showing an embodiment of a grayscale used for analyzing a photograph image, such as the photographic image of FIG. 5

FIGS. 7A and 7B each show an illustration of the photographic image of FIG. 5 when taking from different angles.

FIG. 8 shows a flow chart illustrating an embodiment of a method for analyzing a photographic image indicating status of an insect trap.

FIG. 9 shows a flow chart illustrating an embodiment of a method for pest control with remote monitoring of insect traps.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

The present subject matter relates to, among other things, a method and device for monitoring a state of a sticky board-based insect trap. An example of the insect trap (also known as a fly trap) includes a light source and a sticky board (also known as a glue board). The light source emits a light having characteristics known to attract certain types of insects, such as ultraviolet (UV) light. The sticky board includes a sticky surface that includes an adhesive capable of trapping insects. Such an insect trap can be referred to as an insect light trap (ILT), which emits light (e.g., UV light) from its light source to attract insects to its vicinity and then trap them on its sticky board, effectively removing the insects from the environment without sending tiny insect parts flying around onto nearby surfaces. As used in this document, a “sticky board” can be a sticky paper (e.g., a piece of paper with at least one surface portion coated with an adhesive) or any other structure that including a sticky surface capable of trapping insects.

Efficiency of an ILT depends on factors including (1) the attractiveness of the light source to targeted insects, (2) the area of sticky surface on the sticky board available to trap the targeted insects, and (3) the interaction between (1) and (2) associated with biological behavior of the targeted insects. For factor (2), after the insect trap is deployed, the area of sticky surface available for trapping insects decreases as insects are being captured. To ensure the efficiency of the ILT, in addition to ensuring attractiveness of the light source to the targeted insects, the viability if the sticky board is to be monitored. This requires monitoring for the area of the sticky surface that has already being covered by the captured insects. Such monitoring, when being performed manually and frequently as necessary for insect control efficiency, can be time consuming and costly. For example, for a pest control service provider providing customers with insect elimination services, using ILTs may require frequent visits to customer sites by field technicians and changing sticky boards at regular intervals to maintain efficiency of the insect traps. The field technicians visually inspect the sticky boards at each visit of each customer site to determine the type and number of insects captured. This process can help determine whether each sticky board needs to be replaced and/or determine the level and trend of insect presence as well as possible root causes that have occurred since the last visit. However, such a process when performed manually may be costly due to the time consumed and may not indicate timing of captures that may be of interest for identifying early signs of insect infestation.

The present subject matter improves the efficiency of operating insect traps with sticky boards, such as ILTs, by providing remote monitoring and analysis of status of sticky boards for identifying need for sticky board replacements and/or indications of insect infestation, among other things. The status of sticky boards includes concentration of insects trapped on each sticky board. A need for replacing each sticky board can be signaled when, for example, the concentration of insects trapped on that board exceeds a specified level. This approach can reduce unnecessary visits to the customer sites by the field technicians while preventing the sticky boards from becoming ineffective due to saturation of trapped insects. The concentration of insects trapped on each sticky board also allows for early warning of insect infestation problems in each of the customer sites, allowing for timely adjustment of an insect control strategy.

In various embodiments, the present subject matter provides an ILT with a remote vision system that can take still images of its sticky board and determine the insect concentration by edge image processing. Insects are attracted by the UV light emitted from the ILT and trapped on the sticky board of the ILT. A camera is positioned and oriented to focus on the sticky surface of the sticky board. The content of the sticky surface can be recorded by the camera and analyzed to determine a quantitative measure of the insect concentration. For example, the quantitative measure can be a percentage of the sticky surface that is covered by the trapped insects (and hence has lost stickiness) as determined using edge image processing. The information about ILTs deployed in a customer site can be remotely acquired using such cameras and transmitted to a control center (such as a network-based center of the pest control service provider) to drive actions of pest control for the customer site based on various thresholds and insights as agreed upon between the pest control service provider and the customer.

While an ILT is discussed as an example, the present subject can be applied to any stick-board based insect traps for monitoring that status related to insects trapped. The “concentration of insects trapped” is also referred to as “insect concentration” or “insect saturation” and can be measured by a “percentage of saturation” that refers to the percentage of the sticky surface that is covered by the trapped insects.

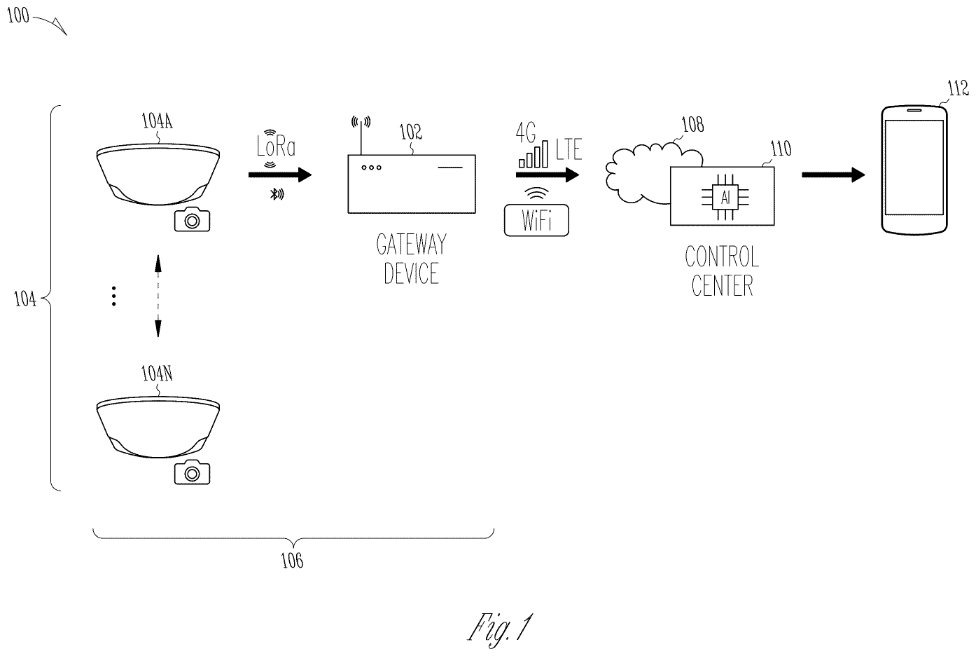

FIG. 1 shows a block diagram illustrating an embodiment of a pest control system 100. Pest control system 100 includes multiple pest control devices 104 (104A-104N), a gateway device 102 communicating with pest control devices 104 using a private edge network 106 such as a LoRa (“long range”), Bluetooth, or Bluetooth Low Energy (BLE) network, a control center 110 on a network 108 that communicates with gateway device 102, and a mobile device 112 (e.g., a smartphone) that communicates with network 108 and gateway device 102. Mobile device 112 can be used, for example, to provision nodes to establish a BLE based network as private edge network 106, with each of pest control devices 104A-104N at a source node transmitting data and gateway device 102 at a destination node receiving data.

Pest control devices 104 can include insect traps, such as ILTs, each including an insect trap to capture insects and a monitoring device to monitor a status of the insect trap and generate a data file including information indicative the status. As illustrated in FIG. 1, the monitoring device can include a camera to capture a photographic image of insects captured in the insect trap and generate an image data file representing the captured photographic image. In one embodiment, the monitoring device includes an image processor to analyze the image data file by edge computing and transmit the results of analysis to control center 102 to gateway device 102 via private edge network 106. In another embodiment, the monitoring device transmits the image data file to gateway device 102 via private edge network 106.

Gateway device 102 can discover pest control devices 104 in its vicinity and to receive the data files including information (e.g., a photographic image) indicative status of insect traps of these pest control devices. In various embodiments, the information indicative the status of the insect trap in each of pest control devices 104 can be acquired and transmitted to gateway device 102 according to a schedule, such as on a periodic basis. In one embodiment, gateway device 102 receives the results of analysis of the image data file from each of pest control devices 104 for further processing and/or transmission to control center 110, for example via WiFi or a cellular network. In another embodiment, gateway device 102 receives the image data files from each of pest control devices 104, analyzes the received image data files by edge computing, and transmits the results of analysis to control center 110, for example via WiFi or a cellular network.

Pest control system 100 is illustrated in FIG. 1 as an example rather than a limitation of an application of the present subject matter. In various embodiments, pest control system 100 can include one or more gateway devices each communicating with multiple pest control devices using the private edge network. For example, control center 110 can be in a pest control service provider's network that communicates with multiple customer sites each having one or more gateway devices communicatively coupled to a system of strategically positioned pest control devices using one or more private edge networks. In various embodiments, pest control system 100 can be part of a larger facilities management system in which the one or more gateway devices in each customer's site communicatively coupled various types of devices using one or more Bluetooth or BLE based networks. The various types of devices can include, for example, pest control devices, warewashing devices, fire suppression systems, and the like in a food service establishment, or pest control devices, warewashing devices, fire suppression systems, office appliances, water safety devices, boilers, laundry machines, housekeeping appliances, cooling towers, pool and spa, and the like in a lodging facility.

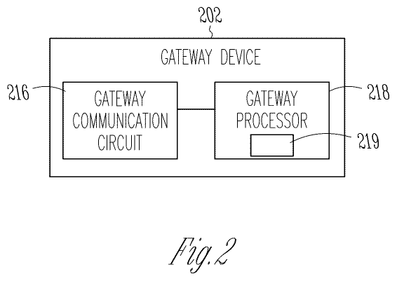

FIG. 2 shows a block illustrating an embodiment of a gateway device 202. Gateway device 202 can represent an example of gateway device 102 and can include a gateway communication circuit 216 and a gateway processor 218. In one embodiment, gateway device 202 is configured to process an image file representing a photograph showing a sticky surface of a sticky board of an insect trap. The photograph can show insects captured on the sticky surface. Gateway communication circuit 216 can receive the image file. Gateway processor 218 can include an image processor 219 (as in the embodiment illustrated in FIG. 2) to generate a grayscale image of the sticky surface by processing the image file and analyze the grayscale image to determine status information indicating a status of the sticky board. The grayscale image can be generated, for example, by converting the photograph to a photographic image in grayscale with specified number of pixels. The status information can include, for example, a measure of insect concentration indicating a concentration of insects trapped on the sticky surface. This embodiment, in which gateway device includes image processor 219, requires transmission of large image data files from pest control devices 104 while reducing computational capability of pest control devices 104.

FIG. 3 shows a block illustrating an embodiment of an insect trap 304. Insect trap 304 can represent an example of insect traps 104. In one embodiment, insect trap 304 can generate the image file to be received by gateway device 102 as discussed above. In another embodiment, insect trap 304 can generate and analyze the image file, as discussed below. Insect trap 304 can include a sticky board 320, a light source 325, a monitoring device 322, and a power supply 326. In the illustrated embodiment, insect trap 304 is an ITL (and hence also referred to as a “fly light”) as an example rather than a limitation. In various embodiments, the present subject matter can apply to insect trap 304 with or without light source 325.

Sticky board 320 includes a sticky surface coated with an adhesive to trap insects. Sticky board 320 can be detachably placed in insect trap 304. Light source 325 can emit a light for attracting targeted insects. Light source 325 can include one or more LEDs. In one embodiment, light source 325 emits ultraviolet (UV) light.

Monitoring device 322 can monitor a status of sticky board 320 including a concentration of insects indicating a percentage of the sticky surface covered by the trapped insects. Monitoring device 322 can include a camera 323, an ambient light sensor 327, an insect trap processor 318, and an insect trap communication circuit 324. Camera 323 can be positioned to take a photograph showing the entire sticky surface of sticky board 320 and generate an image file representing the photograph. In various embodiments, camera 323 be a high-definition (HD) camera.

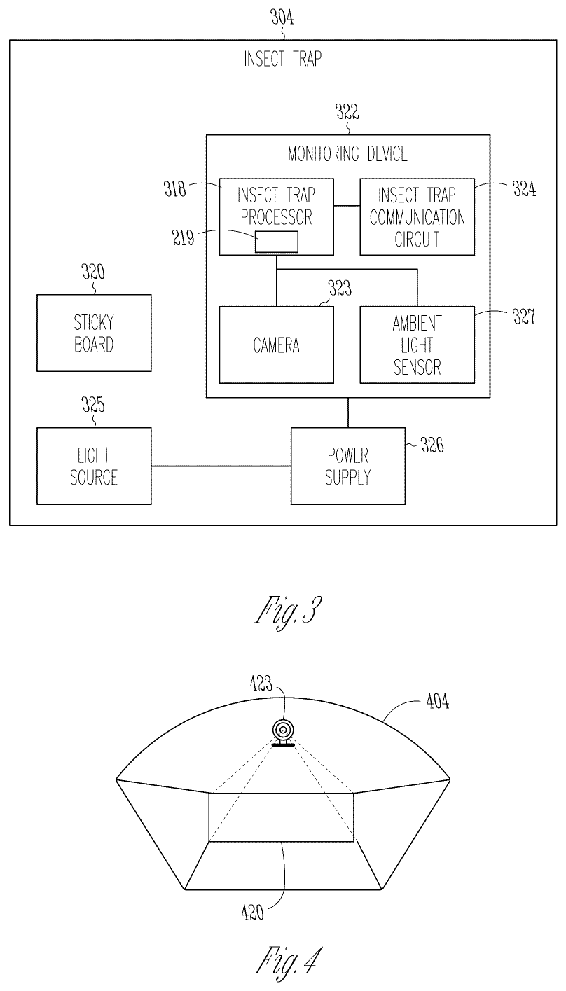

FIG. 4 shows a perspective view illustrating an embodiment of an insect trap 404, which can represent an example of insect trap 304. The view is from top of insect trap 404 showing the camera mounting and a rectangular shaped sticky board 420 placed on the bottom of insect trap 404. In the illustrated embodiment, a camera 423, which represents an example of camera 323, is mounted in insect trap 404 and oriented to ensure that the entire sticky surface of sticky board 420 can be shown in a photograph. In various embodiments, camera 423 is mounted at a height and/or an angle to avoid obstruction of the light source of insect trap 404 in capturing the entire sticky surface. In various embodiments, camera 423 can include a wide-angle lens to capture a full image showing the entire sticky surface from a relatively short distance.

Referring back to FIG. 3, insect trap processor 318 can process the image file generated by camera 323 for analyzing or transmission to gateway device 202. Ambient light sensor 327 can sense a measure of an ambient light that has an optical effect on the photograph. In one embodiment (as illustrated in FIG. 3), insect trap processor 318 includes image processor 219 to generate the grayscale image of the sticky surface by processing the image file and analyze the grayscale image to determine status information indicating the status of the sticky board. Image processor 219 can use the measure of the ambient light sensed by ambient light sensor 327 to compensate for the effect of ambient light in the processing of the image file. Insect trap communication circuit 324 can transmit results of the processing of the image file representing the photograph to gateway device 202. This embodiment eliminates the need for transmission of large image data files to gateway device 202. In another embodiment, in which gateway device 202 includes image processor 219, insect trap communication circuit 324 can transmit the image file representing the photograph and the measure of the ambient light sensed by ambient light sensor 327 to gateway device 202.

In various embodiments, insect trap communication circuit 324 allows insect trap to be included in a network such as private edge network 106, which can be a LoRa, WiFi, or Bluetooth based network (e.g., Bluetooth or BLE beaconing, pairing, or mesh network). In some embodiments, such as when private edge network 106 is a BLE mesh network, insect trap communication circuit 324 can be implemented on a system-on-a-chip microcontroller.

Power supply 326 can supply power to light source 325, monitoring device 322, and insect trap communication circuit 324. In one embodiment, power supply 326 includes one or more batteries. In another embodiment, power supply 326 receives power from power mains. In yet another embodiment, power supply 326 includes one or more rechargeable batteries and receives power from power mains to charge the one or more rechargeable batteries.

Referring back to FIG. 2, gateway communication circuit 216 can communicate with insect trap communication circuit 324 of insect trap 304, such as via private edge network 106, communicate with control center 110, such as via WiFi and/or a cellular network, and optionally mobile device 112, such as via Bluetooth, BLE, WiFi and/or a cellular network. In various embodiments, gateway device 202 is capable of communicating with multiple insect traps (e.g., over 50 insect traps) each being an instance of insect trap 304 or another type of insect trap. In various embodiments, gateway communication circuit 216 can receive the image files from insect trap communication circuit 324 according to a monitoring schedule, such as on a periodic basis. After the image files are analyzed by gateway processor 218, gateway communication circuit 216 can transmit results of the analysis of the received image file to control center 110. In one embodiment, gateway device 202 and insect trap 304 are each an Internet-of-Things (IoT) device.

In various embodiments, mobile device 112 can be configured to directly communicate with pest control devices 104 (including insect trap 304 as its example), for example to receive the image file and/or the results of processing the image file. In various embodiments, mobile device 112 can be configured to directly communicate with pest control devices 104 (including insect trap 304 as its example), gateway device 102 (including gateway device 202 as its example), and/or control center 110, for example to control the acquisition and processing of the photographs taken by pest control devices 104 and/or to receive results of the processing of the photographs.

Gateway processor 218 or insect trap processor 318 can include image processor 219, as discussed above. In other words, gateway processor 218 or insect trap processor 318 can be configured to perform the functions of image processor 219 discussed in this document. Whether to implement image processor 219 in gateway processor 218 or insect trap processor 318 can depend on design considerations and/or constraints (e.g., communication and computational capabilities of each system component. In some embodiments, image processor 219 can be distributed in gateway processor 218, insect trap processor 318, and/or one or more other devices (e.g., control center 110 and mobile device 112).

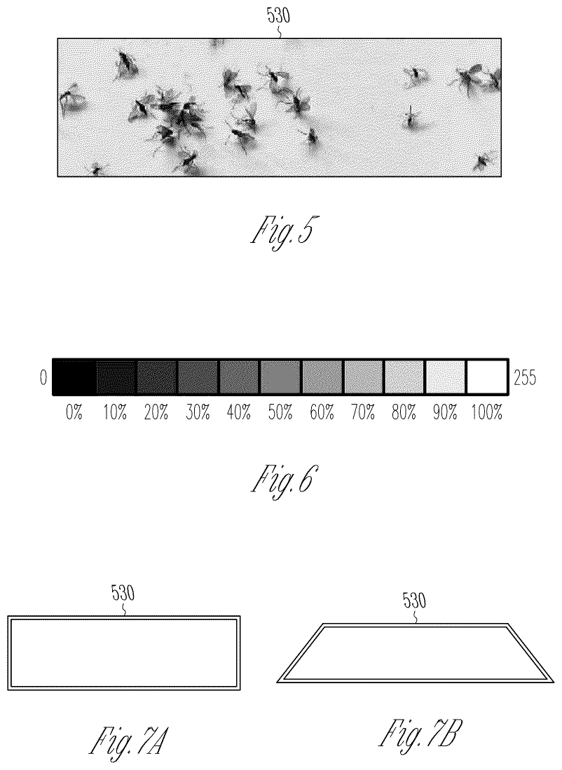

Image processor 219 can receive an image file and generate a grayscale image corresponding to a photographic image 530 represented by the image file. FIG. 5 shows an illustration of a photographic image showing a sticky surface of a sticky board of an insect trap, such as the sticky surface of sticky board 320 of insect trap 304. FIG. 6 shows an illustration showing an embodiment of a grayscale used for analyzing a photograph image, such as photographic image 530. Image processor 219 can, when necessary, crop the photograph into an image showing only the sticky surface and convert the image (showing only the sticky surface) into the grayscale image by extracting the black and white components of the image. Then, image processor 219 can analyze the grayscale image to determine status information indicating a status of the sticky board. Image processor 219 can identify insects trapped on the sticky board using the grayscale image, for example by analyzing each pixel of the grayscale image to determine a numeric value representing the shade of gray. For example, the numeric value can be between 0-255, with 0 being black, 255 being white, and 1-254 being different shades of gray. A trapped insect is indicated for each pixel when the numeric value exceeds a threshold.

Image processor 219 can determine a measure of the concentration of insects on the sticky board based on the analysis of all the pixels of the grayscale image. An example of the measure of concentration insects on the sticky board is the percentage of the pixels for which the numeric values exceed the threshold.

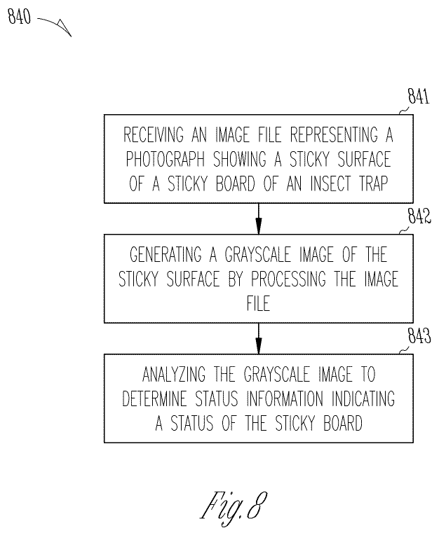

FIGS. 7A and 7B each show an illustration of photographic image 530 when taking from different angles (90 degrees in FIG. 7A and about 45 degrees in FIG. 7B). Image processor 219 can compensate for the angle at which the photograph is taken due to the mounting of the camera. The area of coverage of the sticky board taken by the camera at 90-degrees is more than the area covered by the image take by a camera at an angle other than 90 degrees. The algorithm calculating the concentration of insects on a sticky board needs to account for both the angle of image capture and other environmental challenges. The image processing to calculate the concentration of insects is split into horizontal sections to compensate for the change in image shape and change in shades of gray.

In various embodiments, image processor 219 can generate a saturation alert in response to the measure of insect concentration on the sticky board exceeds a saturation threshold. The saturation threshold can indicate a need for replacing the sticky board. In various embodiments, image processor 219 can send (through gateway communication circuit 216 and/or insect trap communication circuit 324) critical alarm notification to control center 110 and/or mobile device 112 when sticky board reaches saturation threshold.

In various embodiments, image processor 219 can determine a rate of change of the concentration of insects on the sticky board over time. This can include determining amount of increase in the concentration of insects on the sticky board from the concentration determined in a previous analysis. In various embodiments, image processor 219 can send critical alarm notification to control center 110 and/or mobile device 112 when there is abnormal rate of increase in the concentration of insects on the sticky board. In various embodiments, image processor 219 can send (through gateway communication circuit 216 and/or insect trap communication circuit 324) an infestation alarm to control center 110 and/or mobile device 112 in response to the rate of change exceeding an infestation threshold. The infestation threshold can indicate a sign of insect infestation and can be empirically determined for providing preemptive insights into potential insect infestation at customer locations.

In various embodiments, image processor 219 can classify the insects captured on sticky board 320 and/or accurately count the insects captured on sticky board 320 using artificial intelligence, such as leveraging a Computer Vision based Machine Learning capabilities. In various embodiments, image processor 219 can send (through gateway communication circuit 216 and/or insect trap communication circuit 324) the insect classification and/or count to control center 110 and/or mobile device 112. In various embodiments, image processor 219 can divide the sticky surface into grids, analyze the photographic image for each grid, and track change of state (e.g., the numeric value representing the shade of gray) within each grid to provide more detailed information on the status of sticky board 320.

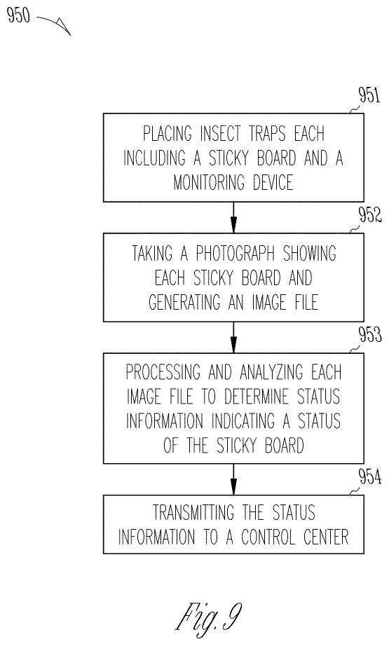

FIG. 8 shows a flow chart illustrating an embodiment of a method 840 for analyzing a photographic image indicating status of an insect trap. In various embodiments, method 840 can be performed using an image processor programmed to process and analyze photographic images according to the present subject matter. Image processor 219 can be implemented in gateway processor 218 of gateway device 202 and/or insect trap processor 318 of insect trap 304. In various embodiments, pest control devices 104, gateway device 102, control center 110, and/or mobile device 112 can each be programmed to perform method 840 or a part of method 840, depending on various design considerations and constraints.

At 841, an image file is received. The image file represents a photograph showing a sticky surface of a sticky board of an insect trap. The photograph can be taken by a high-definition camera, and the image file can have a size of several megabytes.

At 842, a grayscale image of the sticky surface is generated by processing the image file. The processing can include cropping the photograph into an image showing only the sticky surface and converting the cropped image into the grayscale image by extracting the black and white components of the cropped image. The grayscale image can be a photographic image in grayscale that shows the sticky surface including captured insects (if any).

At 843, the grayscale image is analyzed to determine status information indicating a status of the sticky board. The status information can include a measure of insect concentration indicating a concentration of insects trapped on the sticky surface. The analysis can include identifying insects trapped on the sticky board using the grayscale image by analyzing each pixel of the grayscale image to determine a numeric value representing the shade of gray. The analysis can include determining a measure of concentration of the insects on the sticky surface based on the analysis of all the pixels of the grayscale image. The measure can be computed as, for example, the percentage of the pixels for which the numeric values exceed the threshold. In various embodiments, based on the analysis, a saturation alarm can be generated in response to the measure of the concentration of insects on the sticky surface exceeding a saturation threshold. The saturation threshold can indicate a need for replacing the sticky board. In various embodiments, a rate of change of the concentration of insects on the sticky surface over time can be determined. An infestation alarm can be generated in response to the rate of change exceeding an infestation threshold. The infestation threshold can indicate a sign of insect infestation.

FIG. 9 shows a flow chart illustrating an embodiment of a method 950 for pest control with remote monitoring of insect traps. In one embodiment, method 950 is performed using pest control system 100. In one embodiment, method 950 is performed using a pest control system equipped with devices using IoT technology.

At 951, insect traps are placed. The insect traps each include a sticky board and a monitoring device positioned in or about the insect trap. The sticky board are removable from the insect trap for replacement and has a sticky surface capable of trapping insects. The insect traps can be placed strategically, for example in each location where insect activities are seen and/or expected. Method 950 can be performed to allow remote monitoring (e.g., at a pest control service's provider's site) of all the insect traps placed for pest control (e.g., at each customer site being serviced).

At 952, a photograph showing the sticky board is taken, and an image file representing the photograph is generated, using a camera of the monitoring device of each insect trap. In various embodiments, the camera is positioned and oriented to take the photograph covering the entire sticky surface of the sticky board.

At 953, each image file is processed and analyzed to determine status information indicating a status of the stick board associated with the image file. This can be done, for example, by performing method 840 for each image file received. In one embodiment, the processing and analysis are performed by edge computing using a gateway device that receives the image files from multiple insect traps, such as all the insect traps placed in a customer's site or a portion of the site. In another embodiment, the processing and analysis are performed by edge computing using the insect trap that generates the image file, such as each of the insect traps placed in the customer's site or a portion of the site. In various embodiments, the processing and analysis of the image files are performed by one or more image processors in the insect traps, the gateway device, a network-based remote control center, and/or other devices including processors and communicatively coupled to the insect traps, depending on various design considerations and constraints.

At 954, the status information to transmitted to a control center. The status information can include any outcome of performing method 840 (e.g., the concentration of insects determined for each sticky board, the rate of change of the concentration of insects determined for each sticky board, and/or each of the alarms generated). The control center can be a network based control center of a pest control service provider overseeing all the insect traps provided to customers. The transmission can be performed according to a schedule (e.g., on a periodic basis) and/or in response to each of specified events (e.g., an alarm, such as the saturation alarm or the infestation alarm, being generated).

In various embodiments, method 950 can be performed continuously or periodically. The status information generated by performing method 950 can be used to adjust the frequency at which method 950 is performed.

Method 950 can be applied to monitor trapped insects when insect traps need to be inspected and/or replaced on a regular basis and/or as needed. In various embodiments, the present subject matter can be applied to maintain effectiveness of deployed insect traps (e.g., ILTs) while eliminating the laborious task of manually monitoring these insect traps and to identify early signs of insect infestation problem before damage is caused (e.g., to valuable food resources), thereby helping customers maintain high standards of cleanliness and hygiene in their facility.

Some non-limiting examples (Examples 1-25) of the present subject matter are provided as follows:

In Example 1, a system for insect control using insect traps is provided. The insect traps may each include a board having a sticky surface. The system may include a camera and an image processor. The camera may be configured to take a photograph showing the sticky surface of the board of each insect trap of the insect traps and to generate an image file representing the photograph. The image processor may be communicatively coupled to the camera and may be configured to generate a grayscale image of the sticky surface by processing the image file and analyze the grayscale image to determine status information indicating a status of the board, the status information including a measure of a concentration of insects on the sticky surface.

In Example 2, the subject matter of Example 1 may optionally be configured such that the image processor is configured to identify the insects on the sticky surface by analyzing each pixel of the grayscale image to determine a numeric value representing a shade of gray for that pixel and indicating presence of an insect for each pixel when the numeric value exceeds a threshold.

In Example 3, the subject matter of Example 2 may optionally be configured such that the image processor is configured to determine a percentage of the pixels for which the numeric values exceed the threshold.

In Example 4, the subject matter of any one or any combination of Examples 1 to 3 may optionally be configured such that the image processor is configured to generate a saturation alarm in response to the measure of the concentration of insects on the sticky surface exceeding a saturation threshold. The saturation threshold indicates a need for replacing the board.

In Example 5, the subject matter of any one or any combination of Examples 1 to 4 may optionally be configured such that the image processor is configured to determine a rate of change of the concentration of insects on the sticky surface over time.

In Example 6, the subject matter of Example 5 may optionally be configured such that the image processor is configured to generate an infestation alarm in response to the rate of change of the insect concentration exceeding an infestation threshold, and the infestation threshold indicates a sign of insect infestation.

In Example 7, the subject matter of any one or any combination of Examples 1 to 6 may optionally be configured such that the image processor is configured to perform, by analyzing the image file, at least one of classifying the insects on the sticky surface or counting the insects on the sticky surface.

In Example 8, the subject matter of any one or any combination of Examples 1 to 7 may optionally be configured to include a monitoring device in each insect trap of the insect traps, the monitoring device including the camera and the image processor.

In Example 9, the subject matter of Example 8 may optionally be configured such that the monitoring device further includes an ambient light sensor configured to sense a measure of an ambient light, and the image processor is configured to analyze the image file using the sensed measure of the ambient light.

In Example 10, the subject matter of any one or any combination of Examples 1 to 9 may optionally be configured to include a gateway device and the insect traps. The gateway device includes a first communication circuit configured to communicate with each insect trap of the insect traps. The insect traps are communicatively coupled to the gateway device and each include the board including the sticky surface configured to trap insects, a light source configured to emit a light for attracting insect to the sticky surface, a monitoring device including the camera, and a second communication circuit configured to communicate with the first communication circuit.

In Example 11, the subject matter of Example 10 may optionally be configured such that the gateway device includes the image processor, and the second communication circuit is configured to transmit the image file to the image processor through the first communication circuit.

In Example 12, the subject matter of Example 10 may optionally be configured to include a private edge network connecting the gateway device and the insect traps and configured to allow the second communication circuit of each insect trap of the insect traps to communicate with the first communication circuit.

In Example 13, the subject matter of Example 10 may optionally be configured to further include a control center communicatively coupled to the gateway device via a telecommunication network, and such that the first communication circuit is further configured to transmit results of the analysis of the grayscale image to the control center.

In Example 14, a method for insect control insect traps is also provided. The insect traps may each include a board having a sticky surface. The method may include receiving an image file representing a photograph showing the sticky surface of the board of each insect trap of the insect traps, generating a grayscale image of the sticky surface by processing the image file using an image processor, and analyzing the grayscale image to determine status information indicating a status of the board using the image processor. The status information includes a measure of concentration of insects on the sticky surface.

In Example 15, the subject matter of Example 14 may optionally further include placing the insect traps in various locations, positioning a camera in each insect trap of the insect traps, and orienting the camera to take the photograph covering the entire board of the each insect trap.

In Example 16, the subject matter of Example 15 may optionally further include communicating with the cameras using a gateway device configured to wirelessly communicate with each insect trap of the insect traps.

In Example 17, the subject matter of Example 16 may optionally further include including the image processor in the gateway device.

In Example 18, the subject matter of any one or any combination of Examples 14 to 16 may optionally further include including the camera and the image processor in each insect trap of the insect traps.

In Example 19, the subject matter of any one or any combination of Examples 16 to 18 may optionally further include transmitting the status information from the gateway device to a remote control center via a telecommunication network.

In Example 20, the subject matter of any one or any combination of Examples 14 to 19 may optionally further include sensing a measure of an ambient light in the each insect trap, and the subject matter of at least one of the generating the grayscale image or the analyzing the grayscale image as found in any one or any combination of Examples 14 to 19 may optionally include using the measure of an ambient light to compensate an effect of the ambient light on the photograph.

In Example 21, the subject matter of generating the grayscale image as found in any one or any combination of Examples 14 to 20 may optionally include cropping the photograph into an image showing only the sticky surface and converting the image into the grayscale image by extracting the black and white components of the image showing only the sticky surface.

In Example 22, the subject matter of analyzing the grayscale image as found in any one or any combination of Examples 14 to 21 may optionally include analyzing each pixel of the grayscale image to determine a numeric value representing a shade of gray for that pixel and determining a percentage of the pixels for which the numeric values exceed the threshold.

In Example 23, the subject matter of analyzing the grayscale image as found in any one or any combination of Examples 14 to 22 may optionally further include generating a saturation alarm in response to the measure of the concentration of insects on the sticky surface exceeding a saturation threshold. The saturation threshold indicates a need for replacing the board.

In Example 24, the subject matter of analyzing the grayscale image as found in any one or any combination of Examples 14 to 23 may optionally further include determining a rate of change of the concentration of insects on the sticky surface over time.

In Example 25, the subject matter of Example 24 may optionally further include generating an infestation alarm in response to the rate of change exceeding an infestation threshold, the infestation threshold indicating a sign of insect infestation.

The foregoing examples are not limiting or exclusive, and the scope of the present subject matter is to be determined by the specification as a whole, including the claims and drawings.

The above description includes references to the accompanying drawings, which form a part of the detailed description. The drawings show, by way of illustration, varying embodiments in which the invention can be practiced. The application also refers to “examples.” Such examples can include elements in addition to those shown or described. The foregoing examples are not intended to be an exhaustive or exclusive list of examples and variations of the present subject matter.

This application is intended to cover adaptations or variations of the present subject matter. It is to be understood that the above description is intended to be illustrative, and not restrictive. The scope of the present invention should be determined with reference to the appended claims, along with the full scope of legal equivalents to which such claims are entitled.

What is claimed is:

1. A system for insect control using insect traps each including a board having a sticky surface, the system comprising:
a camera configured to take a photograph showing the sticky surface of the board of each insect trap of the insect traps and to generate an image file representing the photograph; and
an image processor communicatively coupled to the camera and configured to:
generate a grayscale image of the sticky surface by processing the image file; and
analyze the grayscale image to determine status information indicating a status of the board, the status information including a measure of a concentration of insects on the sticky surface.

2. The system of claim 1, wherein the image processor is configured to identify the insects on the sticky surface by analyzing each pixel of the grayscale image to determine a numeric value representing a shade of gray for that pixel and indicating presence of an insect for each pixel when the numeric value exceeds a threshold.

3. The system of claim 2, wherein the image processor is configured to determine a percentage of the pixels for which the numeric values exceed the threshold.

4. The system of claim 1, wherein the image processor is configured to generate a saturation alarm in response to the measure of the concentration of insects on the sticky surface exceeding a saturation threshold, and the saturation threshold indicates a need for replacing the board.

5. The system of claim 1, wherein the image processor is configured to determine a rate of change of the concentration of insects on the sticky surface over time.

6. The system of claim 5, wherein the image processor is configured to generate an infestation alarm in response to the rate of change of the insect concentration exceeding an infestation threshold, and the infestation threshold indicates a sign of insect infestation.

7. The system of claim 1, wherein the image processor is configured to perform, by analyzing the image file, at least one of classifying the insects on the sticky surface or counting the insects on the sticky surface.

8. The system of claim 1, comprising a monitoring device in the each insect trap, the monitoring device including the camera and the image processor.

9. The system of claim 8, wherein the monitoring device further comprises an ambient light sensor configured to sense a measure of an ambient light, and the image processor is configured to analyze the image file using the sensed measure of the ambient light.

10. The system of claim 1, comprising:
a gateway device including a first communication circuit configured to communicate with each insect trap of the insect traps; and
the insect traps communicatively coupled to the gateway device, the insect traps each including:
the board including the sticky surface configured to trap insects;
a light source configured to emit a light for attracting insect to the sticky surface
a monitoring device including the camera; and
a second communication circuit configured to communicate with the first communication circuit.

11. The system of claim 10, wherein the gateway device comprises the image processor, and the second communication circuit is configured to transmit the image file to the image processor through the first communication circuit.

12. The system of claim 10, comprising a private edge network connecting the gateway device and the insect traps and configured to allow the second communication circuit of each insect trap of the insect traps to communicate with the first communication circuit.

13. The system of claim 10, further comprising a control center communicatively coupled to the gateway device via a telecommunication network, and wherein the first communication circuit is further configured to transmit results of the analysis of the grayscale image to the control center.

14. A method for insect control using insect traps each including a board having a sticky surface, the method comprising:
receiving an image file representing a photograph showing the sticky surface of the board of each insect trap of the insect traps;
generating a grayscale image of the sticky surface by processing the image file using an image processor; and
analyzing the grayscale image to determine status information indicating a status of the board using the image processor, the status information including a measure of concentration of insects on the sticky surface.

15. The method of claim 14, further comprising:
placing the insect traps in various locations;
positioning a camera in each insect trap of the insect traps; and
orienting the camera to take the photograph covering the entire board of the each insect trap.

16. The method of claim 15, further comprising communicating with the cameras using a gateway device configured to wirelessly communicate with each insect trap of the insect traps.

17. The method of claim 16, further comprising including the image processor in the gateway device.

18. The method of claim 16, further comprising including the camera and the image processor in each insect trap of the insect traps.

19. The method of claim 16, further comprising transmitting the status information from the gateway device to a remote control center via a telecommunication network.

20. The method of claim 14, further comprising sensing a measure of an ambient light in the each insect trap, and wherein at least one of the generating the grayscale image or the analyzing the grayscale image comprises using the measure of an ambient light to compensate an effect of the ambient light on the photograph.

21. The method of claim 14, wherein generating the grayscale image comprises:
cropping the photograph into an image showing only the sticky surface; and
converting the image into the grayscale image by extracting the black and white components of the image showing only the sticky surface.

22. The method of claim 14, wherein analyzing the grayscale image comprises:
analyzing each pixel of the grayscale image to determine a numeric value representing a shade of gray for that pixel; and
determining a percentage of the pixels for which the numeric values exceed the threshold.

23. The method of claim 22, further comprising generating a saturation alarm in response to the measure of the concentration of insects on the sticky surface exceeding a saturation threshold, the saturation threshold indicating a need for replacing the board.

24. The method of claim 22, further comprising determining a rate of change of the concentration of insects on the sticky surface over time.

25. The method of claim 24, further comprising generating an infestation alarm in response to the rate of change exceeding an infestation threshold, the infestation threshold indicating a sign of insect infestation.
